(19) United States
(12) Patent Application Publication
(10) Pub. No.: US 2013/0290408 A1
(43) Pub. Date: Oct. 31, 2013

(54) REMOTING GRAPHICAL COMPONENTS THROUGH A TIERED REMOTE ACCESS ARCHITECTURE

(71) Applicant: Calgary Scientific Inc., Calgary (CA)

(72) Inventors: Matthew James Stephure, Calgary (CA); Christopher James Garrett, Calgary (CA); Monroe Milas Thomas, Calgary (CA)

(21) Appl. No.: 13/860,718

(22) Filed: Apr. 11, 2013

Related U.S. Application Data
(60) Provisional application No. 61/622,561, filed on Apr. 11, 2012.

(51) Int. Cl. H04L 29/08

(52) U.S. Cl. CPC H04L 67/10
USPC 709/203

(57) ABSTRACT

Systems and methods for providing remote access to a JAVA application using views. In accordance with some implementations, the JAVA application may create one or more user interfaces as JPanels. The JPanels may be replaced by remote JPanels that are communicated by a server remote access application to a client computing device. The client computing device execute a client remote access program that instantiates one or more views, where each corresponds to a remoted JPanel. User inputs may be received in the views and synchronized to the JAVA application's user interface.

### CROSS-REFERENCE TO RELATED APPLICATION

This application claims priority to U.S. Provisional Patent Application No. 61/622,561, filed Apr. 11, 2012, entitled “REMOTING GRAPHICAL COMPONENTS THROUGH A TIERED REMOTE ACCESS ARCHITECTURE,” the contents of which are incorporated herein by reference in its entirety.

### BACKGROUND

Ubiquitous remote access to services, application programs and data has become commonplace as a result of the growth and availability of broadband and wireless network access. As such, users are accessing application programs and data using an ever-growing variety of client devices (e.g., mobile devices, table computing devices, laptop/notebook/desktop computers, etc.). Data may be communicated to the devices from a remote server over a variety of networks including, 3G and 3G mobile data networks, wireless networks such as WiFi and WiMax, wired networks, etc. Clients may connect to a server offering the services, applications programs and data across many disparate network bandwidths and latencies.

In such an environment, providing remote access to certain applications, such as those written in JAVA, QT, .Net, requires that the original source code be rewritten to provide for remote access. This can be challenging and time consuming for developers. Other methods of providing remote access are limited and may provide for an unsatisfactory user experience on, e.g., a mobile or tablet device.

### SUMMARY

Disclosed herein are systems and methods for remoting graphical components. The remoting of graphical components may be used to provide access to cross-platform applications, such as JAVA, QT and .Net and other applications, using views. In accordance with some implementations, a JAVA application may create one or more user interfaces as JPanels. For example, the source code of the JAVA application may be changed such that JPanels may be replaced by a remoted JPanel. The remoted JPanels may be communicated by a server remote access application to a client computing device. The client computing device executes a client remote access program that instantiates one or more views, where each corresponds to a remoted JPanel. User inputs may be received in the views and synchronized to the JAVA application's user interface.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is a simplified block diagram illustrating an example system for providing remote access to an application at a remote device via a computer network;

FIG. 2 illustrates additional aspects of a distributed system as applied to the system of FIG. 1;

FIG. 3 illustrates an exemplary user interface having independently controlled views and remoted views;

FIG. 4 illustrates an exemplary operational flow diagram of a process to remote graphical components to a client device in a view;

FIG. 5 illustrates an exemplary operational flow diagram of a process to receive inputs within a view and communicate the inputs to the remoted graphical components;

FIG. 6 illustrates an exemplary user interface showing a puck control;

FIG. 7 is a state model in accordance with the present disclosure;

FIG. 8 illustrates additional aspects of the distributed system as applied to the system of FIGS. 1 and 2; and

FIG. 9 illustrates an exemplary computing device.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. While implementations will be described for remotely accessing applications, it will become evident to those skilled in the art that the implementations are not limited thereto, but are applicable for remotely accessing any type of data or service via a remote device.

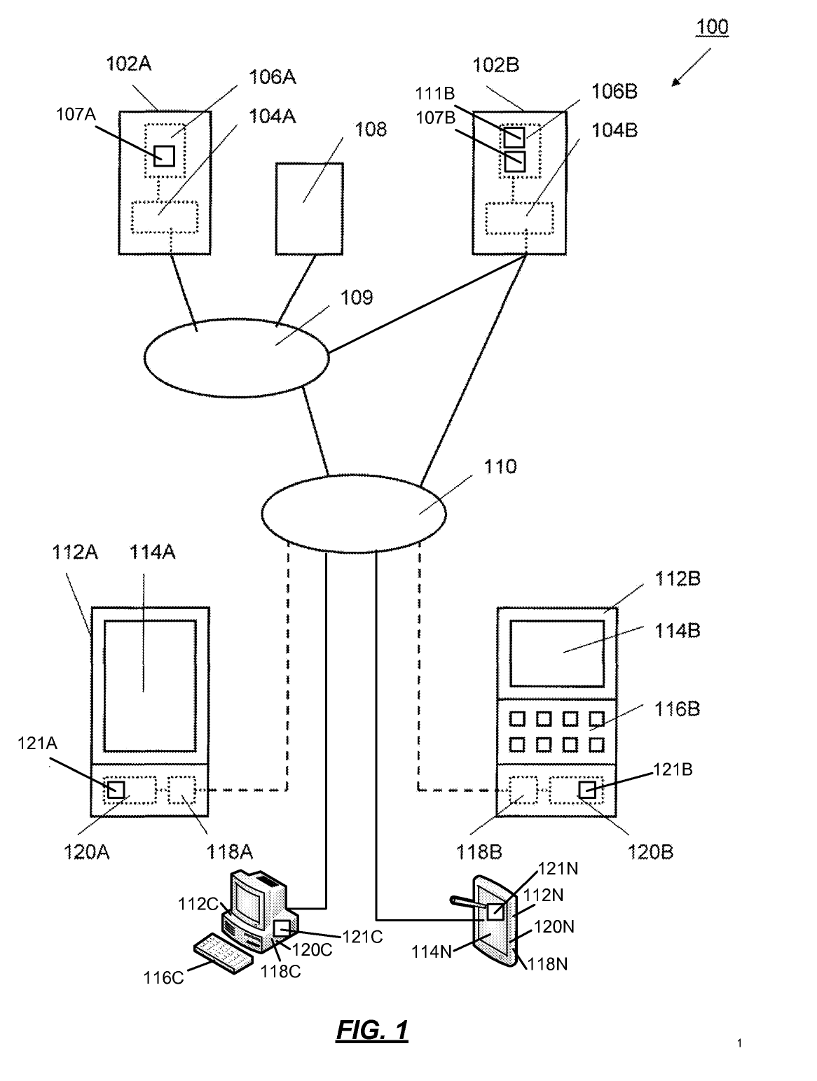

Referring to FIG. 1, there is illustrated an example system 100 for providing remote access to an application, data or other service via a computer network. The system comprises a client computer 112A or 112B, such as a wireless handheld device such as, for example, an IPHONE 112A or a BLACKBERRY 112B connected via a computer network 110 such as, for example, the Internet, to a server 102B. Similarly, the client computing devices may also include a desktop/notebook personal computer 112C or a tablet device 112N that are connected by the communication network 110 to the server 102B. It is noted that the connections to the communication network 110 may be any type of connection, for example, Wi-Fi (IEEE 802.11x), WiMax (IEEE 802.16), Ethernet, 3G, 4G, etc.

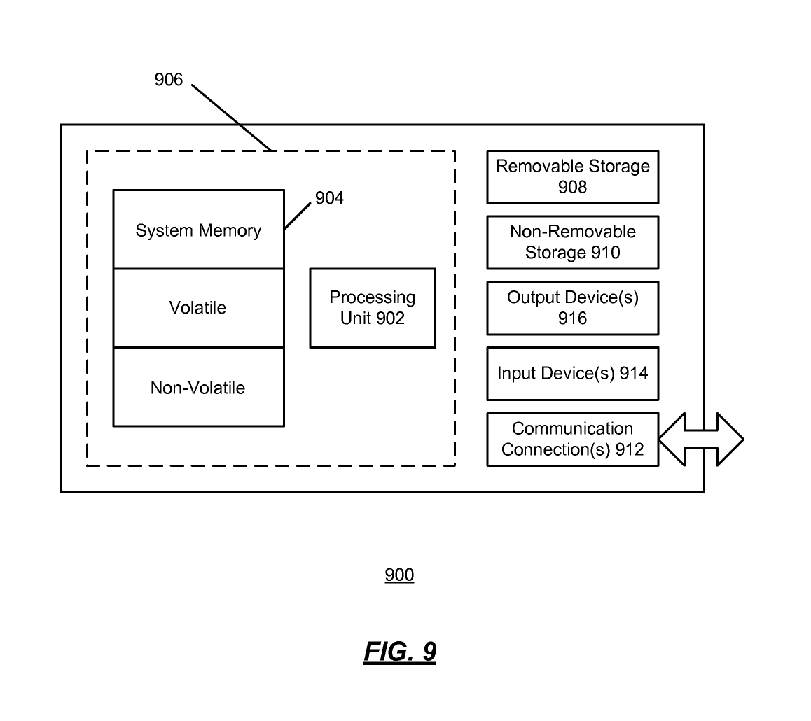

The server 102B is connected, for example, via the computer network 110 to a Local Area Network (LAN) 109 or may be directly connected to the computer network 110. For example, the LAN 109 is an internal computer network of an institution such as a hospital, a bank, a large business, or a government department. Typically, such institutions still use a mainframe computer 102A and a database 108 connected to the LAN 109. Numerous application programs 107A may be stored in memory 106A of the mainframe computer 102A and executed on a processor 104A. Similarly, numerous application programs 107B may be stored in memory 106B of the server 102B and executed on a processor 104B. The application programs 107A and 107B may be “services” offered for remote access. The mainframe computer 102A, the server 102B and the client computing devices 112A, 112B, 112C or 112N may be implemented using hardware such as that shown in the general purpose computing device of FIG. 9.

As will be described, each of the client computing devices 112A, 112B, 112C or 112N may have different physical requirements and capabilities, however, the system 100 enable the delivery of an experience to each of the client computing devices 112A, 112B, 112C or 112N that is appropriate for the particular device and yet common to all devices.

The client remote access application 121A, 121B, 121C, 121N may be designed for providing user interaction for displaying data and/or imagery in a human comprehensible fashion and for determining user input data in dependence upon received user instructions for interacting with the application program using, for example, a graphical display with touch-screen 114A or a graphical display 114B/114N and a keyboard 116B/116C of the client computing devices 112A, 112B, 112C, 112N, respectively. For example, the client remote access application is performed by executing executable commands on processor 118A, 118B, 118C, 118N with the commands being stored in memory 120A, 120B, 120C, 120N of the client computer 112A, 112B, 112C, 112N, respectively.

Alternatively or additionally, a user interface program is executed on the server 102B (as one of application programs 107B) which is then accessed via an URL by a generic client application such as, for example, a web browser executed on the client computer 112A, 112B. The user interface is implemented using, for example, Hyper Text Markup Language HTML 5. In some implementations, the server 102B may participate in a collaborative session with the client computing devices 112A, 112B, 112C or 112N. For example, the aforementioned one of the application programs 107B may enable the server 102B to collaboratively interact with the application program 107A or another application program 107B and the client remote access applications 121A, 121B, 121C, 121N. As such, the server 102B and each of the participating client computing devices 112A, 112B, 112C or 112N may present a synchronized view of the display of the application program.

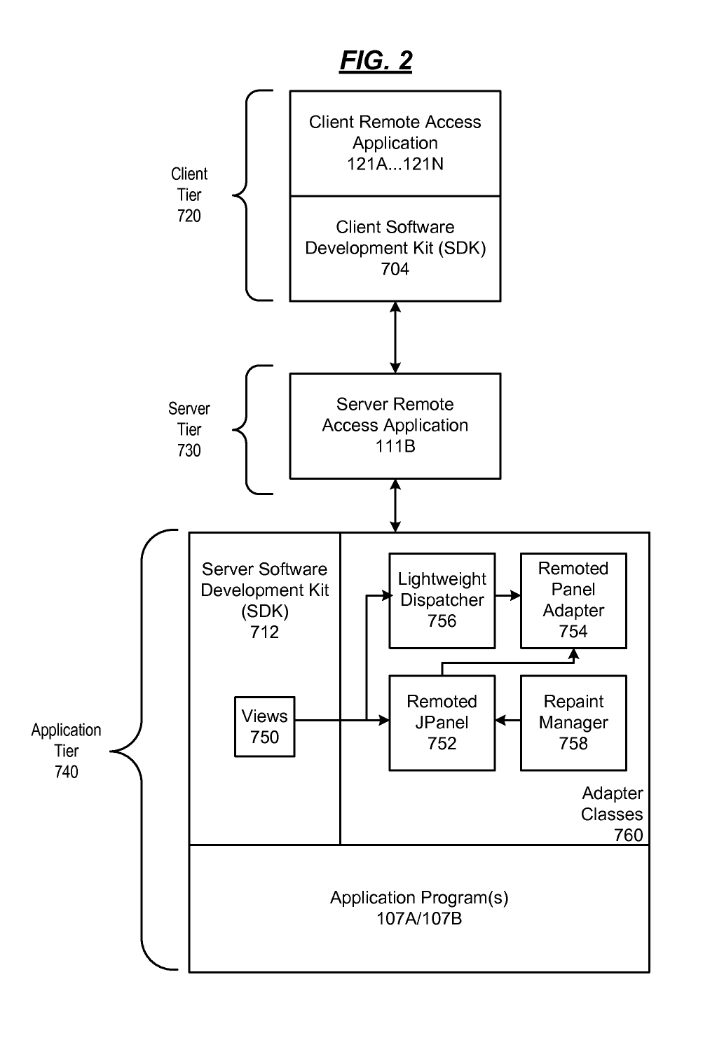

FIG. 2 illustrates aspects of the example system 100 of FIG. 1 in greater detail. The system may have a tiered infrastructure where a client tier 720 and a server tier 730 communicate information, data, messages, etc., between each other. The server tier 730, in turn, communicates the information, data, messages, etc., to an application tier 740. Thus, the server tier 730 may serve as a proxy between the client tier 720 and the application tier 740 during a session between a client (e.g., client computing devices 112A, 112B, 112C or 112N in the client tier 720) and an application (e.g., 107A/107B in the application tier 740).

In the client tier 720, the client remote access application 121A, 121B, 121C, 121N may sit on top of a client software development kit (SDK) 704. The client tier 720 communicates to the server remote access application 111B in a server tier 730.

The server tier 730 may prepare a URL that may be used to access the application 107A/107B. The URL may represent a data structure that the server tier 730 uses to keep track of which client is connected to which service (e.g., application(s) 107A/107B). The server tier may send the URL to the client tier 730, where it may be saved or communicated to other devices. The server tier 730 communicates to a set of adapter classes 760, which may be part of a server SDK 712 that interfaces with the applications 107A/107B in the application tier 740.

In the application tier 740, the adapter classes 760 provide the capability to remote graphical components created by the application 107A/107B. In some implementations where the graphical components are JAVA-based, JPanels may be replaced by a remoted JPanel 752. As known to those of ordinary skill in the art, the JPanel class provides general-purpose containers for lightweight components. The JPanel class part of JAVA Swing, which is a graphical user interface (GUI) widget toolkit to provide a GUI for JAVA programs. Thus, occurrences of JPanel within the source code may be replaced by the remoted JPanel 752, where the remoted JPanel 752 can be consumed by client computing devices by creating named instances of a view 750. The view 750 is a container to display content and to input mouse events, keyboard events and resize events to the application 107A/107B. The view 750 also provides facilities to receive remoted graphics from the application 107A/107B, which are communicated the client tier 720 and presented within a graphical container displayed on the client computing device. In some implementations, the view 750 may be region or collection of components that are remoted as one logical container.

In accordance with some implementations, the view 750 may be updated on-demand as changes occur. A repaint manager 758 coordinates differences between dirty areas on the application 107A/107B (i.e., areas that have changed since a last update), as determined by a JAVA Swing engine, and the view 750. The repaint manager 758 then indicates to an image pipeline which views require an updated render. Rendering is accomplished by passing a Graphics attached to a Remoted Image as the surface for the controls to paint onto. Thus, because updates are performed on-demand, communications between the client and server may be reduced, as there is no need for interval-based polling to take place.

The above provides for an implementation that is distinct from screen scraping. In particular, the adapter classes 760 have knowledge of when the screen has changed. Also, a buffer is provided for JAVA Swing to draw onto in the present implementations, rather than merely capturing screen data from the operating system after the data has been displayed. Thus, in accordance with the architecture shown in FIG. 2, remote access may be provided to cross-platform applications, such as JAVA, QT and .Net and other applications, using views 750. Further, by naming the view 750 in the server tier 740 and the client tier 720, every time the view 750 is updated in the server tier 740, the information placed in the view 750 is automatically transferred to client tier 720. Such an implementation lends itself to applications where updates may occur at any time, such as medical imaging applications, drilling data presentation, etc.

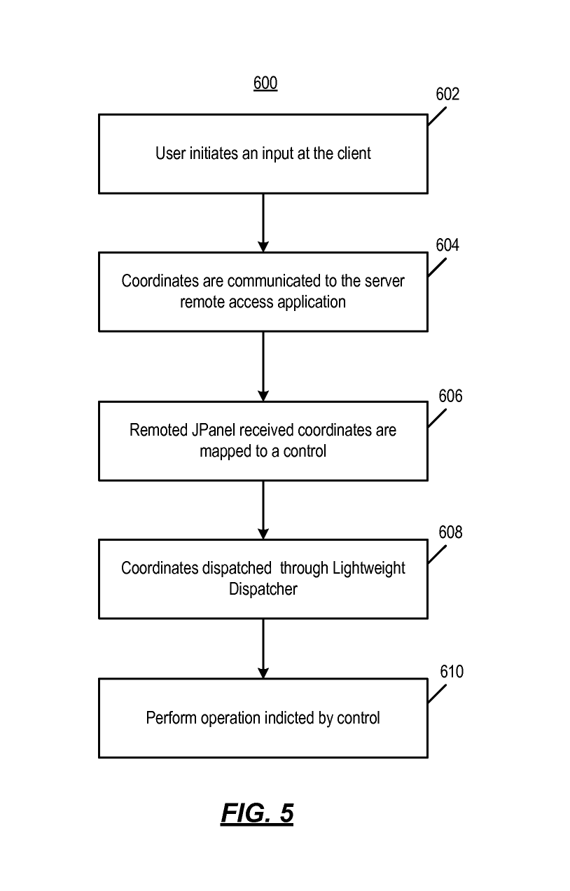

When communicating inputs from a client computing device, a remoted panel adapter 754 takes mouse events from the view 750 (displayed by the client computing device in a graphical container) and directs them to the application 107A/107B executing on the server 102B. Mouse events may be mapped between heavyweight and lightweight controls from the view 750 using a Lightweight Dispatcher 756, as described with reference to FIG. 5, below.

In some implementations, the application tier and server tier may be implemented within a cloud computing environment to provide remote access to the application programs 107A/107B. Cloud computing is a model for enabling network access to a shared pool of configurable computing resources (e.g., networks, servers, storage, applications, and services) that can be provisioned and released with minimal interaction. The cloud computing model promotes high availability, on-demand self-services, broad network access, resource pooling and rapid elasticity. In such an environment, the application programs 107A/107B may be accessed by the client computing devices 112A, 112B, 112C or 112N through a client interface, such as a client remote access application 121A, 121B, 121C, 121N, as described below.

The above example system has been included to illustrate aspects of the disclosure. In light of the present disclosure, those of skill in the art will appreciate that numerous changes, modifications, and alterations may be employed without departing from the scope of the claims appended hereto.

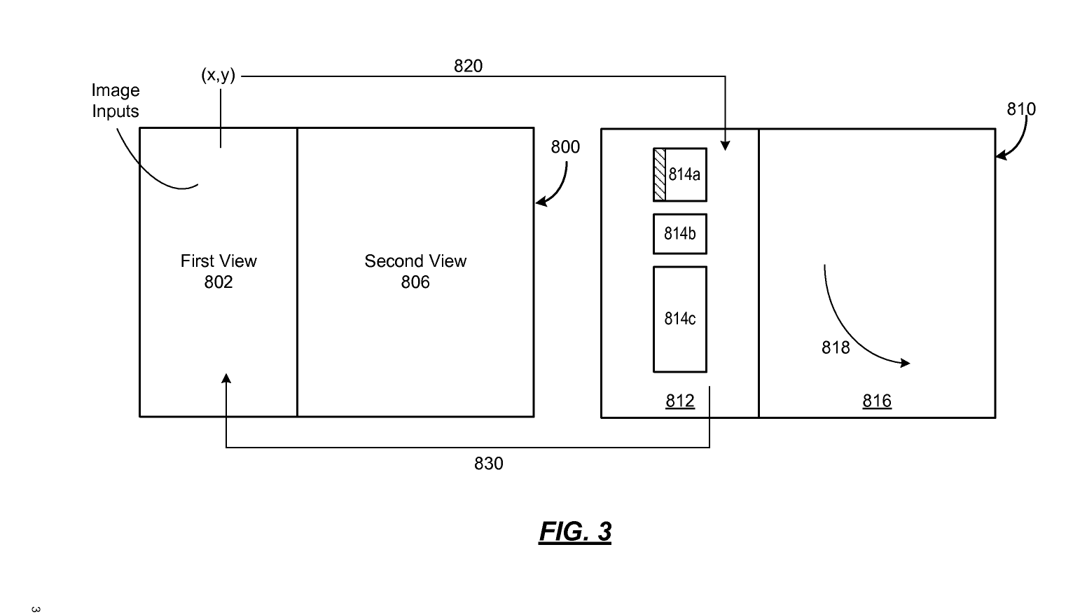

FIG. 3 illustrates an exemplary client user interface 800 having independently controlled views 802 and 806 and remoted views 812 and 186. As shown, the user interface 800 may be displayed at a client computing device 112A-112D. Any number of views displaying any type of graphical component may be provided. The user interface 800 may be created using MICROSOFT SILVERLIGHT, ADOBE FLASH, HTML5, iOS, etc. The first view 802 and the second view 806 may each correspond to an instance of the View(s) 750 generated by the SDK 712 in the application tier 740. Thus, using one or more Views 750, the application 107A/107B may be broken into separate, independently controlled areas within the user interface 800.

The application program 107A/107B may have an associated user interface 810 having, e.g., a remoted first view 812 and a remoted second view 816. Graphical components in the remoted first view 812 and the remoted second view 816 are communicated as the View(s) 750 that are displayed as the first view 802 and the second view 806 by the client user interface 800. The graphical components may be lightweight navigation controls 814a-814b and a JAVA Swing component 814c. The lightweight navigation controls 814a-814b may also be JAVA Swing controls. A heavyweight control such as JAVA 3D control may be displayed in the remoted second view 816. For example, an operation to move or draw an element within the remoted second view 816 may cause a line 818 to be moved or drawn.

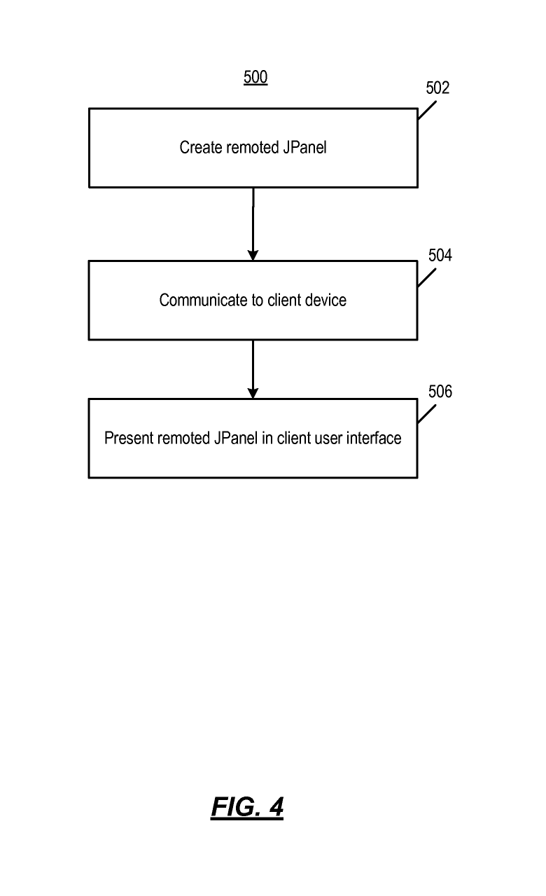

FIG. 4 illustrates an exemplary operational flow diagram of a process to remote JPanels from a server-based application to a client device. At 502, a remoted JPanel is created. The remoted JPanel 752 is a structure that can be communicated and consumed by clients within the tiered architecture as described above. For example the remoted first view 812 having the navigation controls 814a-814c and the remoted second view 816 may be created. At 504, the remoted JPanel is communicated to the client device. For example, the remoted JPanel may be communicated by the server remote access application 111B to the client remote access application 121A, 121B, 121C, 121N. At 506, the remoted JPanel is presented at the client. The remoted JPanel may be displayed as a view in on a display of the client computing device 112A, 112B, 112C or 112N. Thus, the adapter classes 760 within the server tier 740 may communicate remoted JPanels 752 (i.e., the remoted first view 812 and the remoted second view 816) as the first view 802 and the second view 806 displayed on, e.g., displays 114A, 114B . . . 114N, as the client user interface 800.

FIG. 5 illustrates an exemplary operational flow diagram 600 of a process to receive inputs within the client user interface 800 and communicate the inputs to the remoted JPanels. At 602, a user initiates an input at the client. For example, the user touches a position within the first view 802, as displayed on, e.g., the client computing device 114N. The first view 802 may be provided as a remoted JPanel in accordance with the method 500. At 604, the coordinates of the input are communicated to the server remote access application. At 606, the remoted JPanel received coordinates are mapped to a control. For example, a user input may be received at coordinates (x, y) and mapped to control 814a represented by the first view 802. At 608, the coordinates are dispatched through the Lightweight Dispatcher 756 and mapped to the control 814a in the remoted first view 812 of an application user interface 810. For example, the Lightweight Dispatcher 756 navigates a hierarchy of JAVA server controls to determine which control the event received at 602 relates to. At 610, the operation indicated by the user input is performed. For example, the control 814a is actuated and the operation indicated by the control 814a is performed to e.g., move, draw an element within the heavyweight view 816. For example, the control 814a may cause a line 818 to be drawn.

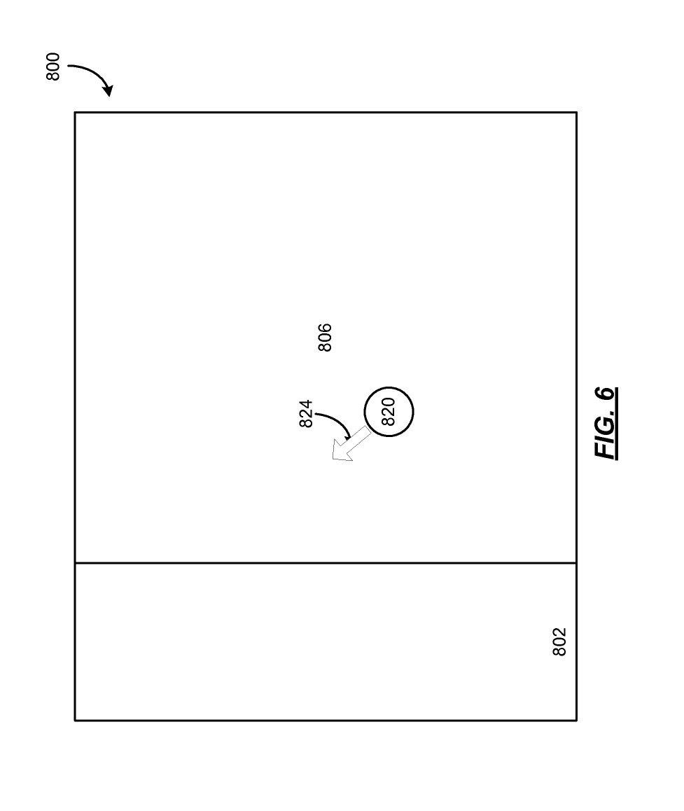

FIG. 6 illustrates an exemplary client user interface showing implementations of a puck control 820. In some implementations, the puck control 820 may be provided to enable certain modes of mouse operation when such modes are not natively available or awkward to complete on the client computing device. For example, in a mouse move mode of operation, a mouse cursor may be moved over a handle in e.g., the second views 806 and 816. The mouse move may provide feedback, such as the handle changing color, or the cursor changing from a pointer to a hand. Another mode may be a mouse drag, where a button is pressed while the user is moving the mouse. This may be used when a user grabs a handle to shrink or grow the handle.

The above modes may be accomplished on, e.g., a touch screen, such as client computing device 112N using the puck control 820 where views presented by the client computing device the server computing device are substantially the same. To facilitate a mouse move, a user may drag the puck control 820 around the touch screen. An arrow 824 may point to an on-screen location. To enter into a drag mode, a user may double tap the puck control 820 which toggles dragging and changes the color of the pointer. Dragging stays ON until the user double taps a second time. The puck control 820 serves to address problems that may arise when a user's finger leaves the surface of the screen, but the desire is not to interrupt the action that the user started. Thus, in accordance with the above, the puck control 820 may provide for “mouse over,” “mouse hover” “mouse move” and “mouse drag” modes of operation. It is noted that the puck control 820 is not limited to such modes, as additional modes may be provided.

Thus, the above provides for remote access to, e.g., a 3D view using a mobile client device, such as an IPAD, ANDROID, or other JAVA client. The client computing device may present the views using a Rich Internet Application (RIA) platform, such as Microsoft's Silverlight, Adobe's Flash, Oracle's JAVA or Apple's iPhone. Further, very little integration is needed to provide the above-functionality. For example, a relative few lines of code in a source application would need to be modified/added together with the adapter classes (repaint manager 789, Lightweight Dispatcher 756, remoted panel adapter 754, and remoted JPanel 752).

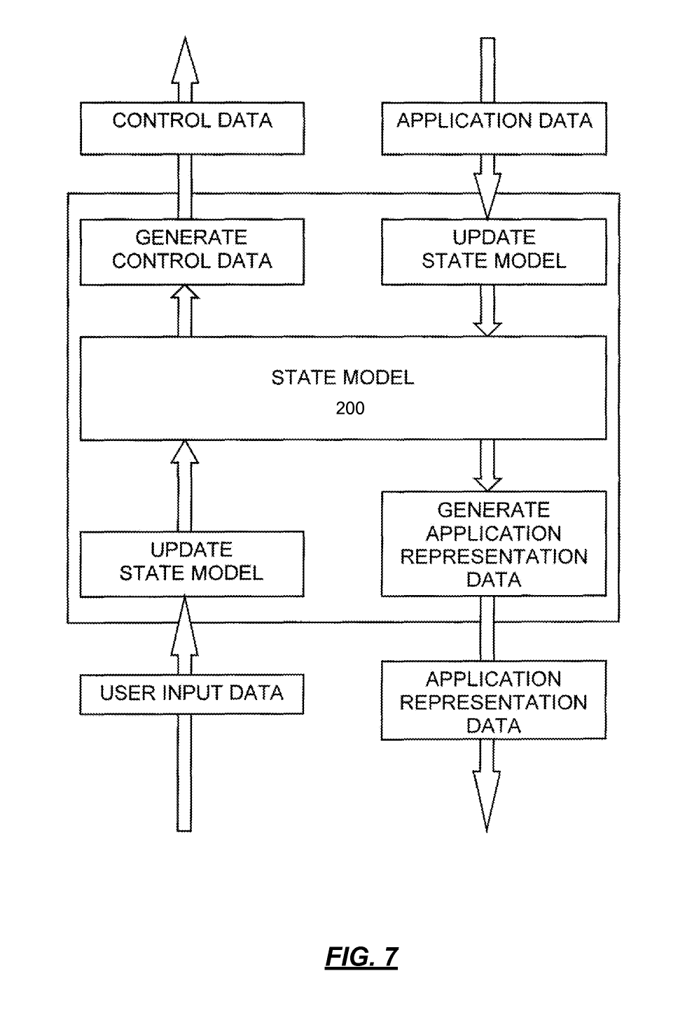

Referring now to FIG. 7, the operation of a server remote access application 111B with the client remote access application (any of 121A, 121B, 121C, 121N, or one of application programs 107B is performed in cooperation with a state model 200. An example of the server remote access application is PUREWEB, available from Calgary Scientific, Alberta, Canada. When executed, the client remote access application updates the state model 200 in accordance with user input data received from a user interface program. The remote access application may generate control data in accordance with the updated state model 200, and provide the same to the server remote access application 111B running on the server 102B.

Upon receipt of application data from an application program 107A or 107B, the server remote access application 111B updates the state model 200 in accordance with the screen or application data, generates presentation data in accordance with the updated state model 200, and provides the same to the client remote access application 121A, 121B, 121C, 121N on the client computing device. The state model 200 comprises an association of logical elements of the application program with corresponding states of the application program, with the logical elements being in a hierarchical order. For example, the logical elements may be a screen, a menu, a submenu, a button, etc. that make up the application program user interface. This enables the client device, for example, to natively display the logical elements. As such, a menu of the application program that is presented on a mobile phone will look like a native menu of the mobile phone. Similarly, the menu of the application program that is presented on desktop computer will look like a native menu of the desktop computer operating system.

The state model 200 is determined such that each of the logical elements is associated with a corresponding state of the application program 107A or 107B. The state model 200 may be determined such that the logical elements are associated with user interactions. For example, the logical elements of the application program are determined such that the logical elements comprise transition elements with each transition element relating a change of the state model 200 to one of control data and application representation data associated therewith.

The state model 200 may be represented in, e.g., an Extensible Markup Language (XML) document. Other representations of the state model are possible. Information regarding the application program and the measuring tool are communicated in the state model. The state model 200 may thus contain session information about the application itself, an application extension, information about views, and how to tie the functionality of the application to the specific views.

In some implementations, two or more of the client computing devices 112A, 112B, 112C . . . 112N and/or the server 102B may collaboratively interact with the application program 107A or 107B. As such, by communicating state information between each of the client computing devices 112A, 112B, 112C . . . 112N and/or the server 102B and/or the mainframe computer 102A participating in a collaborative session, each of the participating client computing devices 112A, 112B, 112C . . . 112N may present a synchronized view of the display of the application program 107A or 107B.

In accordance with some implementations, the system 100 may provide for application extensions. Such extensions are provided as part of either the server remote access application 111B, the client remote access applications 121A, 121B, 121C, 121N, or both to provide features and functionalities that are otherwise are not provided by the application programs 107A or 107B. These features and functionalities may be provided without a need to modify the application programs 107A or 107B, as they are integral with the remote access applications.

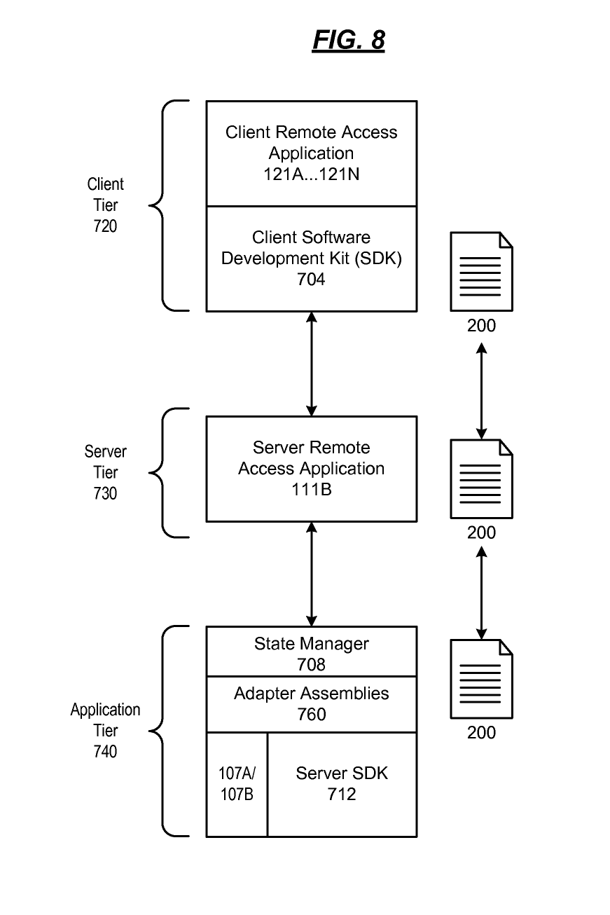

As shown in FIG. 8, the tiered architecture includes the state model 200, which coexists with the adapter classes 760 provided to remote graphical components, such as JPanels. Thus, while graphical components may be remoted within the tiered architecture, other elements, such as a splash screen may be captured within the state model 200 and communicated between the application 107A/107B and the client remote access application 121A . . . 121N.

FIG. 9 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 9, an exemplary system for implementing aspects described herein includes a computing device, such as computing device 900. In its most basic configuration, computing device 900 typically includes at least one processing unit 902 and memory 904. Depending on the exact configuration and type of computing device, memory 904 may be volatile (such as random access memory (RAM)), non-volatile (such as read-only memory (ROM), flash memory, etc.), or some combination of the two. This most basic configuration is illustrated in FIG. 9 by dashed line 906.

Computing device 900 may have additional features/functionality. For example, computing device 900 may include additional storage (removable and/or non-removable) including, but not limited to, magnetic or optical disks or tape. Such additional storage is illustrated in FIG. 9 by removable storage 908 and non-removable storage 910.

Computing device 900 typically includes a variety of computer readable media. Computer readable media can be any available media that can be accessed by device 900 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 904, removable storage 908, and non-removable storage 910 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 900. Any such computer storage media may be part of computing device 900.

Computing device 900 may contain communications connection(s) 912 that allow the device to communicate with other devices. Computing device 900 may also have input device(s) 914 such as a keyboard, mouse, pen, voice input device, touch input device, etc. Output device(s) 916 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method of providing remote access to an application executed on a server computing device, comprising:
determining at least one remoted graphical component associated with a user interface of the application;
associating the at least one remoted graphical component with a view, the view being a container to display content and to receive inputs to the application; and
communicating the view to a client computing device over a network communication link using a server remote access application.

2. The method of claim 1, further comprising:
determining differences between the at least one remoted graphical component and the view; and
communicating the differences to the client device.

3. The method of claim 2, wherein a repaint manager and a JAVA Swing Engine determine differences between the view and graphical user interface element generated by the application.

4. The method of claim 2, further comprising performing on-demand synchronization as changes occur in the at least one remoted graphical component.

5. The method of claim 1, wherein the at least one remoted graphical component comprises a JAVA JPanel.

6. The method of claim 1, further comprising:
receiving an input within a client user interface displayed on a client computing device;
communicating coordinates of the input to a server remote access application;
mapping the coordinates to the remoted graphical component; and
determining an application control in accordance with the coordinates to perform an action associated with the input.

7. The method of claim 6, further comprising receiving the input within the view.

8. The method of claim 7, further comprising mapping mouse events received within the view to the remoted graphical component.

9. The method of claim 7, further comprising mapping keyboard events received within the view to the remoted graphical component.

10. The method of claim 6, wherein the remoted graphical component comprises a JAVA JPanel.

11. The method of claim 6, further comprising providing a puck control to facilitate mouse movements.

12. A server computing device adapted to provide remote access to an application, comprising:
a memory that stores computer executable instructions; and
a processor;
wherein when the computer executable instructions are executed on the processor, the server computer determines at least one remoted graphical component associated with a user interface of the application, associates the at least one remoted graphical component with a view that is a container to display content and to receive input events to the application, and communicates the view to a client computing device over a network communication link using a server remote access application.

13. The server computing device of claim 12, wherein the server determines differences between the at least one remoted graphical component and the view, and wherein the differences are communicated to the client device.

14. The server computing device of claim 13, wherein a repaint manager and a JAVA Swing Engine determine differences between the view and graphical user interface element generated by the application.

15. The server computing device of claim 12, wherein the at least one remoted graphical component comprises a JAVA JPanel.

16. A method for providing remote access between a client computing device and an application executed on a server computing device, comprising:
receiving an input within a client user interface displayed on the client computing device;
communicating coordinates of the input to a server remote access application executing on the server computing device;
mapping the coordinates to a remoted graphical component associated with the application; and
determining an application control in accordance with the coordinates to perform an action at the application associated with the input.

17. The method of claim 16, further comprising receiving the input within the view.

18. The method of claim 17, further comprising mapping mouse events received within the view to the remoted graphical component.

19. The method of claim 17, further comprising mapping keyboard events received within the view to the remoted graphical component.

20. The method of claim 16, wherein the remoted graphical component comprises a JAVA JPanel.
